(19) United States
(12) Patent Application Publication
(10) Pub. No.: US 2005/0094300 A1
(43) Pub. Date: May 5, 2005

(54) Method and apparatus for write control in a disk drive

(75) Inventors: Koji Yano, Ome-shi (JP); Kan Takahashi, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/976,341

(22) Filed: Oct. 29, 2004

(30) Foreign Application Priority Data
Oct. 31, 2003 (JP) 2003-372450

(51) Int. Cl. G11B 27/36; G11B 5/09

(52) U.S. Cl. 360/31; 360/46

(57) ABSTRACT

There is disclosed a disk drive having a write controller which effectively inhibits a PTP phenomenon at a write operation time. The write controller is a CPU which changes write conditions for alleviating the PTP phenomenon on production of a write error at the write operation time. The CPU changes a write current value set to a register of a head amplifier circuit to a low current value, and executes a write operation. The CPU changes the write current value in stages until the write error is inhibited.

### CROSS-REFERENCE TO RELATED APPLICATIONS

This application is based upon and claims the benefit of priority from prior Japanese Patent Application No. 2003-372450, filed Oct. 31, 2003, the entire contents of which are incorporated herein by reference.

### BACKGROUND OF THE INVENTION

1. Field of the Invention

The present invention generally relates to a disk drive, particularly to a write control which suppresses a PTP phenomenon of a head.

2. Description of the Related Art

In general, in a disk drive represented by a hard disk drive, a magnetic head (hereinafter referred to simply as a head) has been used having a write head for recording data on a disk medium (hereinafter referred to simply as a disk), and a read head for reproducing the data from the disk.

The head concretely has a structure in which a write head element and a read head element are mounted on a head body referred to as a slider.

In the write head, a recording magnetic field is applied to the disk in accordance with a write current (recording current) flowing through a coil to perform magnetic recording of the data.

In the disk drive, the head (slider) is held by an actuator in such a manner that the head flies above the disk. An interval between the flying head and the disk is maintained at a micro distance referred to as a flying height.

On the other hand, minimizing of the flying height has been pushed forward in order to largely enhance a recording/reproducing capability of the data with rising of a recording density. On the other hand, however, a drop of the flying height raises a possibility of contact of the head with a disk face, and this is a factor that lowers reliability of a recording/reproducing operation.

Additionally, a phenomenon has been confirmed in which a head material (slider) thermally expands by heat generated in passing a current through the coil of the write head. This phenomenon is referred to as a pole tip protrusion (PTP).

When particularly the head material positioned in the vicinity of a magnetic recording pole of the write head thermally largely expands by this PTP phenomenon, an expanded portion of the head (slider) approaches a disk surface, and, as a result, the flying height drops. Therefore, when the flying height of the head drops especially by the PTP phenomenon at a write operation time, a possibility that the head contacts the disk surface increases.

Needless to say, a large flying height margin is taken in consideration of a drop of the flying height by the PTP phenomenon in a case where the disk drive is designed, and a crash by the contact of the head with the disk surface is avoided. However, when the flying height margin is increased, a drop of the recording/reproducing capability of the head is caused, and the PTP phenomenon is preferably suppressed.

Since the PTP phenomenon is a problem of the head material or structure, the material and structure can be changed to suppress the phenomenon. Concretely, a prior technique has been proposed in which head processing or a head material is devised to reduce the PTP phenomenon (see, for example, Jpn. Pat. Appln. KOKAI Publication No. 2003-141704).

However, it is actually difficult to reduce the PTP phenomenon which influences the flying height indicating a micro distance, for example, of 10 nm only by improvement of the material or the structure of the head.

### BRIEF SUMMARY OF THE INVENTION

In accordance with an embodiment of the present invention, there is provided a disk drive having a function capable of effectively suppressing a PTP phenomenon at a write operation time by a write control.

The disk drive comprises: a head which records data on a disk medium in accordance with a write current supplied to a coil; an actuator on which the head is mounted and which positions the head in a target position on the disk medium; and a write controller which changes write conditions to execute a write operation in a case where a write error is produced at a write operation time at which the data is recorded in the target position on the disk medium by the head.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a major part of a disk drive according to an embodiment of the present invention;

FIG. 2 is an explanatory view of a structure of a head and a PTP phenomenon according to the present embodiment;

FIG. 3 is a diagram showing a relation between the number of WF times and a write current by the PTP phenomenon according to the present embodiment;

FIG. 4 is an explanatory view of the write current according to the present embodiment;

FIG. 5 is a diagram showing a relation between the number of the WF times and the number of continuous data sectors according to the present embodiment;

FIG. 6 is a diagram showing a relation between the number of the WF times and a temperature in the drive according to the present embodiment;

FIG. 7 is a diagram showing one example of distinction information according to the present embodiment;

FIG. 8 is a flowchart showing a procedure of a first write control method according to the present embodiment;

FIG. 9 is a flowchart showing a procedure of a second write control method according to the present embodiment; and

FIG. 10 is a flowchart showing a procedure of a third write control method according to the present embodiment.

### DETAILED DESCRIPTION OF THE INVENTION

An embodiment of the present invention will be described hereinafter with reference to the drawings.

(Constitution of Disk Drive)

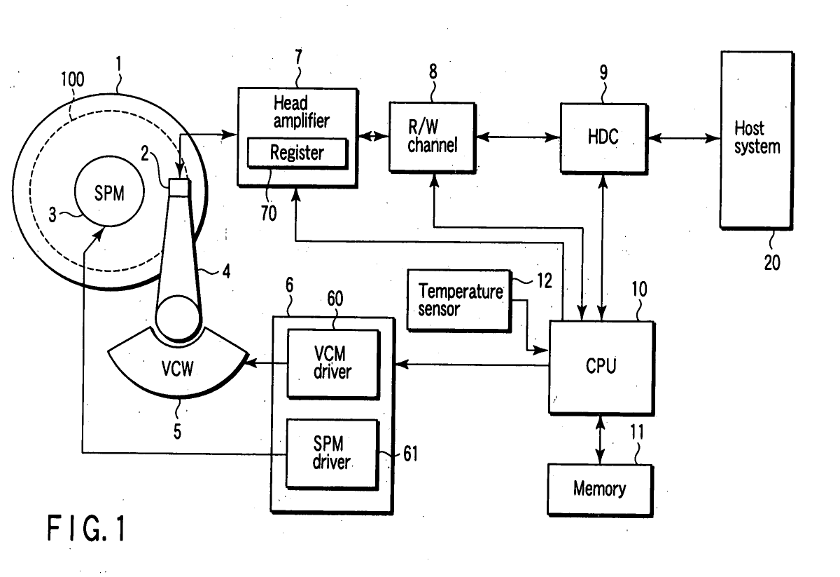

FIG. 1 is a block diagram showing a major part of a disk drive according to the present embodiment.

The disk drive is fixed to a spindle motor (SPM) 3, and has a disk 1 rotated at high speed, and a head 2 for recording or reproducing data with respect to the disk 1.

A large number of tracks 100 for recording the data are constituted on the disk 1. Each track 100 includes a servo area in which servo data is recorded, and a data sector in which user data is recorded. The servo data is used in positioning control for positioning the head 2 into a target position on the disk 1.

The head 2 is mounted on an actuator 4 driven by a voice coil motor (VCM) 5. A driving current is supplied to the VCM 5 by a VCM driver 60 included in a motor driver IC 6. The motor driver IC 6 includes an SPM driver 61 together with the VCM driver 60, and is controlled by a CPU 10.

The head 2 has a structure including a slider as a head body on which a read head for executing a read operation, and a write head for executing a write operation are mounted. The actuator 4 is driven/ controlled by the CPU 10, and the head 2 is positioned in a target position on the disk 1.

In addition to a head disk assembly, the disk drive comprises a circuit system including a head amplifier circuit 7, a read/write (R/W) channel 8, a disk controller (HDC) 9, a microprocessor (CPU) 10, and a memory 11.

The head amplifier circuit (pre-amplifier circuit) 7 has a read amplifier which amplifies a read signal output from the read head, and a write amplifier. The write amplifier converts a write data signal output from the R/W channel 8 into a write current signal, and sends the signal to the write head.

The head amplifier circuit 7 includes a register 70 for adjusting a write current value (recording current value) included in write conditions at a write operation time. The register 70 is accessed by the CPU 10 to set a designated write current value. The write amplifier of the head amplifier circuit 7 supplies the write current to the coil of the write head in accordance with the write current value set to the register 70.

The R/W channel 8 is a signal processing IC which processes a read/write data signal (including a servo data signal). The HDC 9 has a function of an interface between the drive and a host system 20 (e.g., a personal computer or a digital apparatus).

The CPU 10 is a main control device of the drive, and executes a positioning control operation of the head 2, a read/write operation control, and a write control associated with the PTP phenomenon. The memory 11 includes a flash memory which is a nonvolatile memory, RAM, ROM and the like, and stores various types of data and programs necessary for the control of the CPU 10.

Furthermore, the present drive includes a temperature sensor 12 for detecting especially an ambient temperature of the head 2 in the drive. The temperature sensor 12 detects a temperature at a certain sampling interval, and outputs a detected value of the temperature to the CPU 10. The CPU 10 monitors a temperature fluctuation following the detection of the temperature from the temperature sensor 12.

(Structure of Head and PTP Phenomenon)

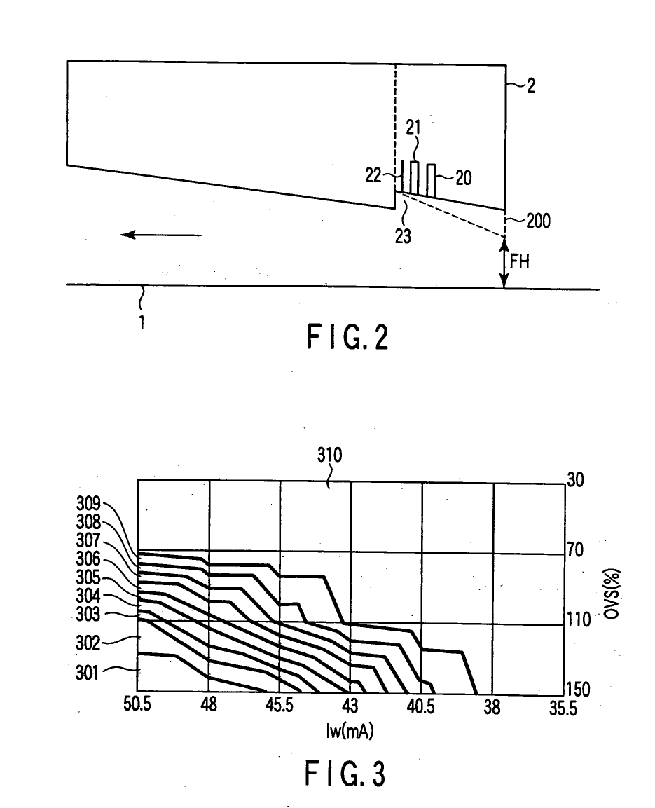

FIG. 2 is an explanatory view of a structure of the head 2 and a PTP phenomenon in the present embodiment.

The head 2 has a write head comprising a magnetic recording pole (main magnetic pole) 20, a return yoke or a coil (not shown) and the like, and a read head having a read head element (e.g., giant magnetoresistive [GMR] element) 22 disposed in the vicinity of the write head via a shielding member 21.

The head 2 includes the slider on which the read and write heads are mounted as a main body, and is mounted on the actuator 4. The slider is formed, for example, of a material such as alumina, and a recess 23 is formed on a side facing the surface of the disk 1 as shown in FIG. 2. It is to be noted that an arrow shown in FIG. 2 indicates a running direction of the head 2 with respect to the disk 1.

A write current is passed through the coil of the write head at a write operation time to generate a recording magnetic field from the main magnetic pole 20, and magnetic recording is performed on the disk 1. Here, to raise the magnetic recording capability, the recording magnetic field of the write head is enlarged. A method of increasing a write current value is general in order to enlarge the recording magnetic field. The write current value can be set, for example, to about 60 mA at maximum.

As shown in FIG. 2, the head (slider) 2 flies above the disk surface by a flying height which is a micro distance. In recent years, the flying height has been reduced, for example, to about 10 nm in order to enhance the recording/reproducing capability.

In such tendencies to reduce the flying height and increase the write current, as described above, it has been requested that the PTP phenomenon be suppressed or reduced. In the PTP phenomenon, it has been presumed as a factor that the coil generates heat to raise the ambient temperature at a time when the write current flows through the coil of the write head at a write operation time. That is, when the temperature rises, as shown in FIG. 2, a portion 200 causing large thermal expansion is generated based on a coefficient of thermal expansion of the material (e.g., alumina) of the head 2 in the vicinity of the coil.

By this PTP phenomenon, an interval between the head 2 and the disk 1 is reduced by the expanded portion 200, and, as a result, a flying height (flying height FH) decreases. Therefore, the flying posture of the head 2 is non-stabilized, and a possibility that the head contacts or collides with the disk 1 increases.

Especially, with occurrence of the PTP phenomenon, when the head 2 is positioned in a target position on the disk 1, a positioning error (deterioration of positioning precision) is produced by the contact with the surface of the disk 1, and, as a result, a write error is generated at the write operation time.

(First Write Control Method)

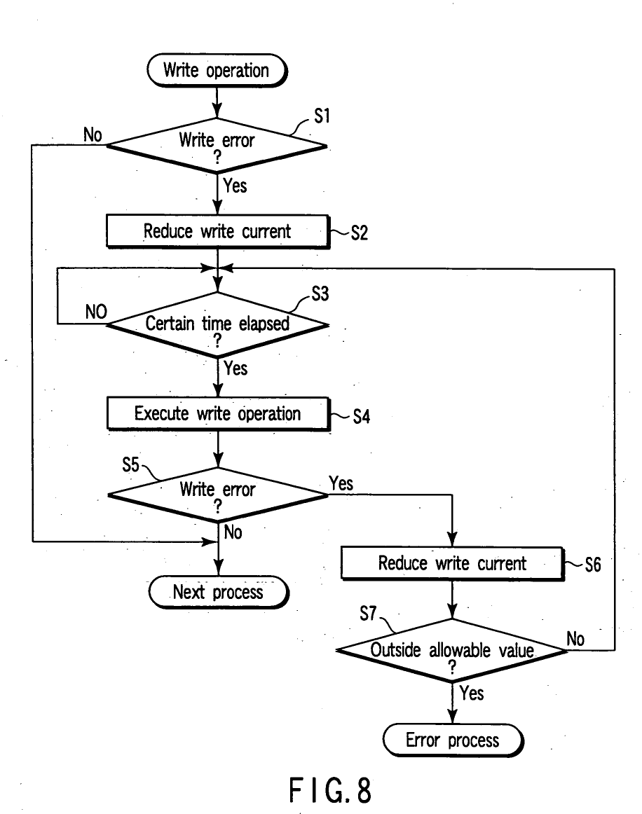

FIG. 8 is a flowchart showing a procedure of a first-write control method according to the present embodiment.

A PTP phenomenon occurs by a factor of heat generated by a write current flowing through the coil of a write head. Therefore, in a first write control method, a write current value is reduced at the time of the occurrence of the PTP phenomenon.

As shown in FIG. 8, when a write error (write fault, hereinafter referred to as WF in some case) is generated at a write operation time, the CPU 10 judges that the PTP phenomenon has occurred, and shifts to a process of lowering the write current included in write conditions (YES in step S1, S2).

Here, when the flying height of the head 2 is reduced by the PTP phenomenon, and positioning by the contact with the disk 1 is deteriorated at the time of a positioning operation of the head 2, the CPU 10 judges that the write error has been generated.

Concretely, the CPU 10 changes a rated write current value set to the register 70 of the head amplifier circuit 7 to a reduced write current value. Furthermore, the CPU 10 executes a write operation with a changed write current after elapse of a certain time (YES in step S3, S4). By the elapse of the certain time, the heat generation of the head 2 is reduced.

When the write error is produced even at the write operation time with the changed write current, the CPU 10 further reduces the write current value of the register 70 (YES in step S5, S6). That is, the CPU 10 reduces the write current value in a stepwise manner until no write error is produced, and executes a write operation (NO in step S7, S3 to S5).

To reduce the value from a rated current value in a stepwise manner, after the value falls to an allowable value (e.g., about 25 mA) necessary for the write operation, and when the write error is still produced, the CPU 10 stops the write operation and shifts to a predetermined error process (YES in step S7). In this case, it is presumed that the generation of the write error is a factor other than the PTP phenomenon.

It is to be noted that the CPU 10 returns the reduced write current value to the rated current value when ending the write operation. Alternatively, the reduced write current value is maintained until a power supply of the disk drive is turned off, and the rated current value is set when the power supply is turned on.

As described above, when the write current is reduced at the time of the generation of the write error, a heat generation temperature of the coil of the write head is lowered, and the occurrence of the PTP phenomenon can be suppressed or reduced. Therefore, positioning deterioration of the head by the PTP phenomenon-is improved, and, as a result, the write error can be eliminated.

FIG. 3 is a figure showing results of measurement of the number of write errors (WF) produced by the PTP phenomenon using a write current (Iw) and an overshoot of the write current as parameters. That is, FIG. 3 shows results 301 to 310 of the measurement of a WF number range every ten stages from the measurement result 301 in a case where the number of the WFs is 90 to 100 to the measurement result 310 in a case where the number of the WFs is 0 to 10.

The WF of the present embodiment is a situation in which a head positioning precision is degraded by the contact of the head 2 with the disk 1, attributed to the PTP phenomenon, at a time when the write operation is executed, and accordingly the write operation cannot be executed.

The write current will be described in accordance with a waveform in a disk drive of a vertical magnetic recording system.

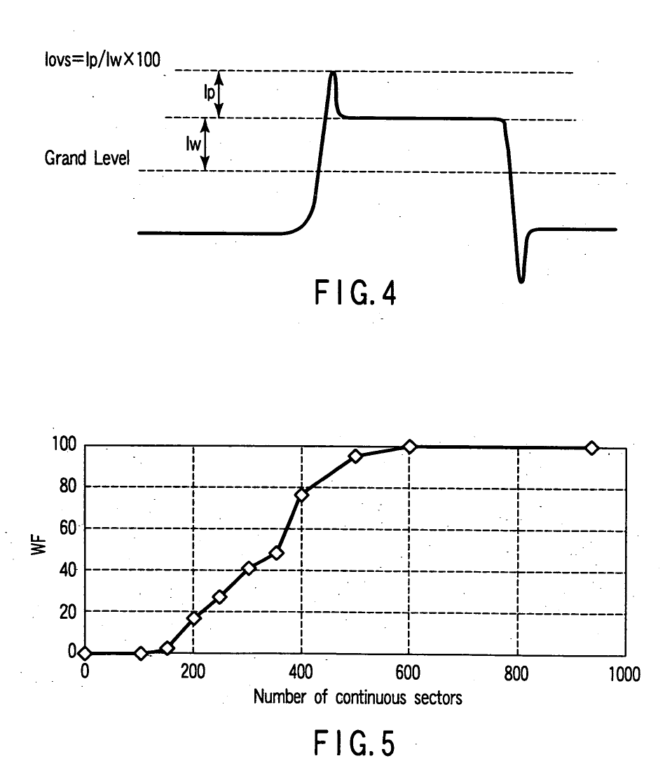

As shown in FIG. 4, the overshoot (Iovs) of the write current is a ratio of a current Ip flowing for a rising time at a polarity reversing time of the write current Iw. As shown in FIG. 3, it can be confirmed that the number of the WFs increases when the write current Iw or the overshoot (Iovs) increases. In this case, when Iw or Iovs increases, the amount of generated heat of the coil of the write head increases. Therefore, the degree of PTP increases. This tendency is similarly seen in a disk drive of a longitudinal magnetic recording system. In the first write control method, the write current Iw is reduced to thereby suppress the degree of the PTP.

(Second Write Control Method)

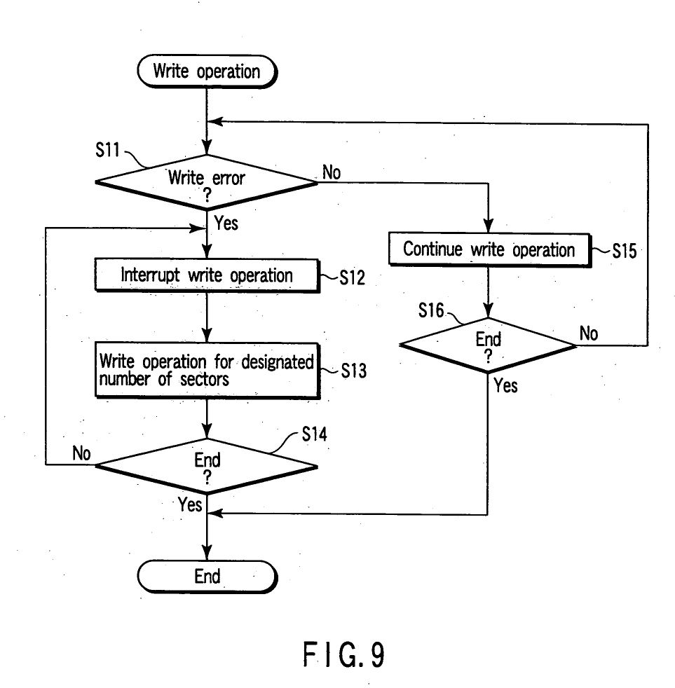

FIG. 9 is a flowchart showing a procedure of a second write control method according to the present embodiment.

It is presumed that a PTP phenomenon does not depend on a momentary heat amount of a coil of a write head, and is influenced by integration of heat amounts by previous continuous write operations. Therefore, the second write control method is a method of restricting the time of the continuous write operation, in other words the number of continuous data sectors which are write operation objects.

As shown in FIG. 9, when a write error (WF) is generated at a write operation time, the CPU 10 judges that the PTP phenomenon has occurred, and discontinues the write operation (YES in step S11, S12). That is, when the PTP phenomenon occurs by the integration of the heat amounts by the continuous write operation, and positioning is degraded by the contact with the disk 1 at a time of a positioning operation of the head 2, the CPU 10 judges that the write error has been produced.

In the write operation for data sectors, requested from the host system 20, the CPU 10 executes the write operation for the designated number of the data sectors, and discontinues the write operation (step S13). That is, the CPU 10 intermittently executes the write operation for the designated number of the data sectors including discontinuance of the write operation until the write operation for the number of the data sectors to be subjected to the write operation ends (step S14).

It is to be noted that in a case where no write error is produced, the CPU 10 continuously executes the write operation for the data sectors as requested by the host system 20 (NO in step S11, S15, S16).

As described above, the time of the write operation, that is, the number of the data sectors for which the write operation is to be continuously executed is restricted, an interruption operation, for example, to wait for one rotation of the disk 1 is temporarily executed, and accordingly the heat amount of the coil of the write head is reduced. Accordingly, it is possible to suppress or reduce the occurrence of the PTP phenomenon. Therefore, the positioning deterioration of the head by the PTP phenomenon is improved, and, as a result, the write error can be eliminated.

FIG. 5 shows results of measurement of the number of WFs produced by the PTP using the number of the data sectors written at the time of one rotation of the head 2 around a track on the disk 1 as a parameter. Here, a case where the write operation is executed with respect to 936 sectors which are continuous data sectors is shown.

It can be confirmed from FIG. 5 that when the number of the data sectors of the write operation is decreased, the number of the WFs accordingly decreases. That is, it is seen that the PTP does not depend on the momentary heat amount of the coil, and is influenced by the integration of heat amounts for the previous several hundreds of sectors. Then, in the second write control method, the number of the continuous data sectors for which the write operation is executed at once is decreased, and accordingly the degree of PTP is suppressed.

(Third Write Control Method)

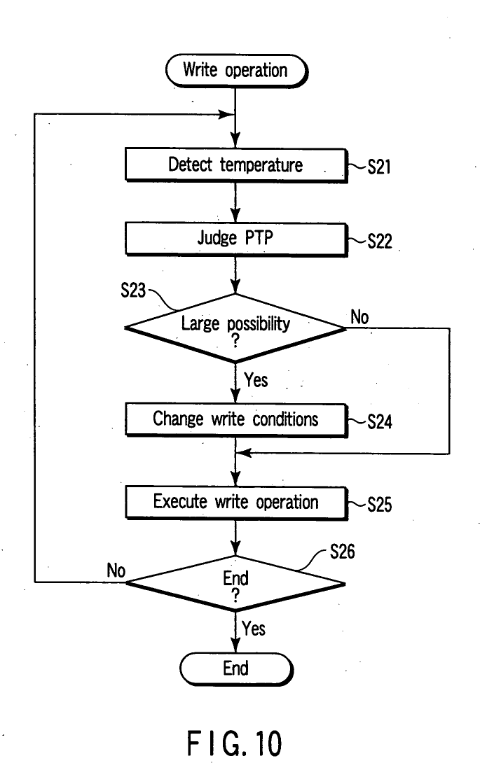

FIG. 10 is a flowchart showing a procedure of a third write control method according to the present embodiment.

It is presumed that a PTP phenomenon is influenced by not only heat generation of a coil of a write head but also a heat amount at an ambient temperature in a drive. Then, in the third write control method, the ambient temperature (especially the ambient temperature of the head 2) in the drive is monitored, and write conditions are changed in a case where a possibility of occurrence of PTP is high.

The CPU 10 confirms the ambient temperature in the drive based on a detected value of the temperature from the temperature sensor 12 during execution or before start of the write operation (step S21). Next, the CPU 10 refers to judgment information stored, for example, in a flash memory of the memory 11 to judge a possibility of generation of a PTP phenomenon (step S22).

As shown in FIG. 7, the judgment information is, for example, table information of a matrix constitution. The judgment information indicates conditions for experimentally judging the possibility of the occurrence of the PTP phenomenon beforehand using an ambient temperature T in the drive and the write current Iw.

The CPU 10 refers to the judgment information, and can accordingly confirm that no WF is produced by a factor of PTP, for example, in a case where a detection temperature T is 40 degrees and the write current value Iw is 50 mA or less (NO in step S23).

On the other hand, the CPU 10 refers to the judgment information, and accordingly judges that a possibility of producing of the WF caused by the PTP is high, for example, in a case where the detection temperature T exceeds 50 degrees and the write current value Iw exceeds 40 mA (YES in step S23). In this case, the CPU 10 changes the write conditions, and executes the write operation in order to prevent the PTP from being caused beforehand (steps S24, S25).

Concretely, the CPU 10 decreases the write current value Iw, for example, to 40 mA or less in the same manner as in the above-described first write control method. Accordingly, the WF can be prevented beforehand from being caused by the occurrence of the PTP at the write operation time.

It is to be noted that a method in which the CPU 10 changes the write conditions is not limited to the reduction of the write current value Iw, and a method may be performed in which the number of the data sectors of the continuous write operation is restricted, and the write operation is executed in the same manner as in the above-described first write control method. In this case, information indicating a relation between the number of the continuous data sectors and the ambient temperature is prepared as judgment information, and accordingly the number of the data sectors can be restricted and set with a high precision.

As described above, the possibility of the occurrence of the PTP phenomenon is judged based on the judgment information indicating the relation between the ambient temperature T in the drive and the write current Iw during the execution or before the start of the write operation. Accordingly, in a case where the possibility of the occurrence of the PTP phenomenon is high, the write conditions including the reduction of the write current value in the write operation are changed, and accordingly the productions of the WF can be prevented beforehand from being caused by the occurrence of the PTP. The write conditions include the restriction of the time of the write operation, that is, the number of the data sectors to be subjected to the continuous write operation, the interruption operation, for example, to temporarily wait for one rotation of the disk 1 and the like.

In the present method, based on the temperature detection result, it can be presumed that the possibility of the production of the WF caused by the PTP is low in a case where the write current value Iw is, for example, 50 mA or less. Therefore, the number of times at which the write current value Iw is reduced or the write conditions including the restriction on the number of the continuous data sectors are changed can be reduced. This has an effect that performance degradation of the disk drive can be suppressed.

It is to be noted that since the judgment information is associated with characteristics or the like of the head 2, the information can be prepared by a unit of a head lot or the like. Here, to check the PTP for each head unit, for example, a shipping test or the like is utilized. The WF is measured in various environments while changing write conditions such as Iw, Iovs, and the number of continuous data sectors, and the judgment information indicating optimum conditions on which the WF indicates 0 may be stored in the memory 11. The judgment information preferably include a generation intensity which is a generation probability of the WF, and conditions on which the generation of the WF is zeroed.

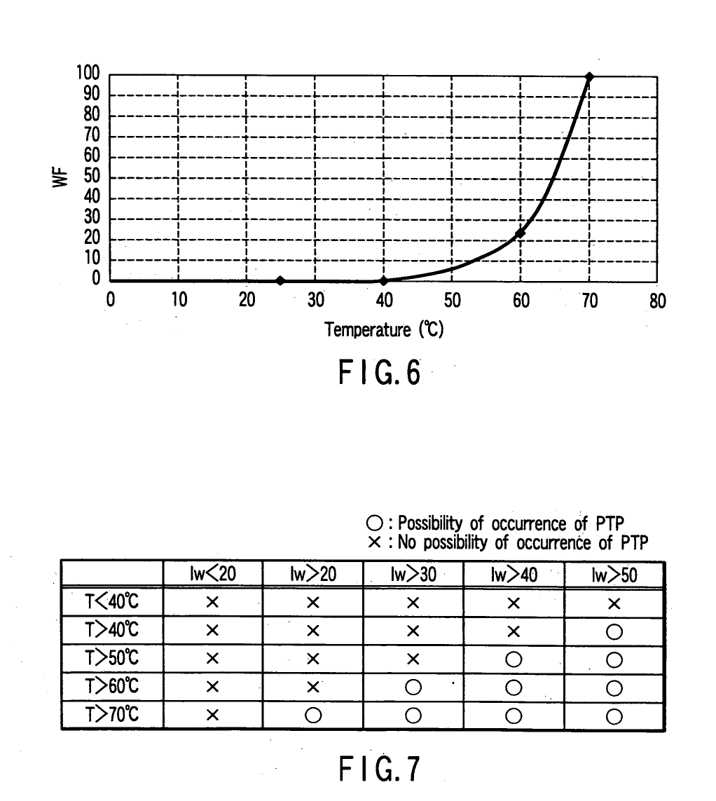

FIG. 6 is a figure showing results of measurement of the number of the WFs generated by the PTP using the ambient temperature in the drive as a parameter. It can be confirmed from FIG. 6 that when the ambient temperature in the drive rises, the ratio of the number of the WFs increases.

It is to be noted that when the write current Iw is changed in accordance with the change of the write conditions, the CPU 10 maintains the current value Iw in the register 70, and uses the value until the ambient temperature changes or the power supply of the drive is turned off.

Furthermore, as the change of the parameter of the write conditions, Iovs which strongly depends on the generation of the WF is effectively used as a parameter together with the write current value Iw. Concretely, as shown in FIG. 3, for example, in a case where Iw is 48 mA and Iovs is 110%, the write conditions are changed to Iw of 43 mA and Iovs of 70% in a write head in which the number of the WFs is 50 or more. Then, the number of WFs is 10 or less.

Furthermore, when Iw is changed to 38 mA, and Iovs is changed to 70%, the number of the WFs can be set to 0. The CPU 10 stores the write conditions in the memory 11. Accordingly, when the WF is generated, the write conditions are set, and the production of the write error by the PTP can be effectively inhibited.

It is to be noted that when the write current value Iw is reduced, needless to say, the recording capability of the drive is reduced. Therefore, a lower limit value of the drop of the write current value Iw, and a maximum range of the drop are preferably set beforehand. In this case, for example, when the WF does not indicate 0 even by the reduction of the write current value Iw from the rated value to 10 mA, the CPU 10 may discontinue the reduction of the write current value Iw, and shift to the second write control method.

As described above, in short, according to the present embodiment, the write current value is reduced, the continuous time of the write operation is reduced (the number of the continuous data sectors is reduced), the possibility of the occurrence of the PTP is judged by monitoring the ambient temperature in the drive, and the coil heat amount is suppressed by the temporary interruption of the write operation. Accordingly, the production of the WF by the PTP phenomenon can be suppressed. Thereafter, it is possible to realize a stable write operation as a result.

As described above, in short according to the present embodiment, not by the improvements of the head material and structure, but by the write control to change the write conditions at the write operation time, associated with the heat generation of the write head, the reduction of the PTP phenomenon can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A disk drive comprising:
a head which records data on a disk medium in accordance with a write current supplied to a coil;
an actuator on which the head is mounted and which positions the head in a target position on the disk medium; and
a write controller which changes write conditions to execute a write operation in a case where a write error is generated at a write operation time when the head records the data in the target position on the disk medium.

2. The disk drive according to claim 1, wherein the write controller reduces the write current into an allowable range from a rated value as the write conditions when detecting the generation of the write error, and executes the write operation in accordance with the reduced write current.

3. The disk drive according to claim 1, wherein the write controller reduces the write current into an allowable range from a rated value in stages as the write conditions when detecting the generation of the write error, and executes the write operation in accordance with the write current in each stage.

4. The disk drive according to claim 1, wherein the write controller reduces the write current into an allowable range from a rated value as the write conditions when detecting the generation of the write error, and further executes the write operation in accordance with the reduced write current after elapse of a certain time.

5. The disk drive according to claim 1, wherein the write controller discontinues the write operation for a certain time, when detecting the generation of the write error, and continues the write operation after elapse of the certain time.

6. The disk drive according to claim 1, wherein the write controller includes interruption of the write operation for a certain time as the write conditions in a case where the write error is generated at a write operation time when the data for a plurality of data sectors is continuously recorded, and intermittently executes the write operation for the designated number of the data sectors.

7. A disk drive comprising:
a head which records data on a disk medium in accordance with a write current supplied to a coil;
an actuator on which the head is mounted and which positions the head in a target position on the disk medium;
a temperature sensor which detects an ambient temperature of the head;
a unit which judges a possibility of generation of a pole tip protrusion (PTP) based on the ambient temperature detected by the temperature sensor and a write current value supplied to the head; and
a write controller which reduces the write current value as write conditions to execute a write operation in a case where a judgment result of the judgment unit indicates a high possibility of the generation of the PTP at a write operation time.

8. The disk drive according to claim 7, further comprising:
a memory to store judgment information for the judgment of the possibility of the generation of the pole tip protrusion (PTP) using the write current value and the ambient temperature of the head as parameters,
wherein the judgment unit judges the possibility of the generation of the PTP using the ambient temperature detected by the temperature sensor, the write current value to be supplied to the head, and the judgment information.

9. The disk drive according to claim 7, wherein the write controller restricts the number of continuous data sectors as the write conditions to execute the write operation in a case where the possibility of the generation of the PTP is high.

10. A method of write control for a disk drive that includes a head for writing data in a disk medium in accordance with write current, the method comprising:
detecting generation of a write error at a write operation time when the data is recorded onto the disk medium by the head;
executing reduction of the write current; and
executing the write operation in accordance with the reduced write current.

11. The method according to claim 10, wherein the executing of the write operation includes: executing the write operation in accordance with the reduced write current after elapse of a certain time after the write current is reduced.

12. The method according to claim 10, further comprising: after the step of executing the write operation,
detecting the generation of the write error; and
reducing the write current into an allowable range in stages.

13. The method according to claim 10, wherein the executing of the write operation after detecting the generation of the write error in a case where data for a plurality of data sectors is continuously recorded as the write operation includes: interrupting the write operation for a certain time; and intermittently executing the write operation for the designated number of the data sectors.

14. The method according to claim 10, further comprising:
detecting an ambient temperature of the head at the write operation time;
judging a possibility of generation of a pole tip protrusion (PTP) based on the ambient temperature and a write current value to be supplied to the head; and
changing write conditions in a case where the possibility of the generation of the PTP is high.
